(19) United States
(12) Patent Application Publication
(10) Pub. No.: US 2005/0198486 A1
(43) Pub. Date: Sep. 8, 2005

(54) Information technology development transformation

(75) Inventors: Andrew Desmond, County Dublin (IE); Ciaran Quilty, Dublin (IE); Anne Renehan, Dublin (IE)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 10/977,473

(22) Filed: Nov. 1, 2004

Related U.S. Application Data
(60) Provisional application No. 60/537,141, filed on Jan. 20, 2004.

(51) Int. Cl. G06F 9/00

(52) U.S. Cl. 713/1

(57) ABSTRACT

The present invention provides approaches to assist the practitioner in transforming information technology (IT) development organizations. The methods are repeatable for implementation among multiple IT development organizations, yet can be tailored to the individual needs of each organization. The methods are designed to address the challenges faced by IT development organizations due to financial factors, customer needs, internal operations, and overall corporate organization. In preferred implementation, the present invention provides transformation workstreams that implement actions as needed to expedite the IT development transformation. The IT development transformation workstreams includes a transformation leadership workstream, a vision & operating model workstream, a management controls workstream, a customer management workstream, a development processes and tools workstream, an organizational development workstream, and a program management workstream 1100. Each of these workstreams includes a number of substreams and components. Many of these Workstreams are performed concurrently, thereby offering an expedited, more efficient transformation.

### CROSS REFERENCE TO RELATED APPLICATIONS

This application claims priority under 35 U.S.C. §119 (e) to U.S. Provisional Patent Application No. 60/537,141, “Methods for Information Technology Development Transformation,” filed Jan. 20, 2004, which is hereby incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates, in general, to the efficient development of information technology in the corporate environment. More specifically, the present invention provides methods to assist the practitioner in executing development transformation projects.

2. Description of the Related Art

A strong core information technology (IT) capability is vital to enable business growth. Many businesses typically create separate internal organizations to develop IT solutions. IT operations, i.e., efforts that focus on the actual operations of IT products and systems, have been the focus of attention to improve internal processes and maximize efficiency. However, IT development organizations, i.e., the organization and people that actually write software codes and compose IT products, have received comparatively little attention as an area for organizational optimization. IT development transformation has been an area that has not been exploited, and very few people have looked at creating projects around the development workforce. One reason for this lack of attention is because this area employs quite different measurements than other business organizations. Thus, there remains a need for an improving IT development organizations so as to make them more cost-effective, measurable, and efficient.

Many IT development organizations face significant challenges due to financial factors, customer needs, internal operations, and overall corporate organization. Financial challenges may include, for example, an escalating IT cost base, excessively high non-discretionary spending, low return on investment from IT projects, and poor vendor and contractor management. Customer-related challenges may come from either internal customers or external customers. Customer-related challenges may include, for example, low customer satisfaction, the perception of the IT organization as a cost center and not as a trusted business adviser, an unclear/passive relationship of IT to the business, and poor project prioritization/governance process. Challenges related to internal operations may include, for example, poor management information, a lack of clarity on the number and/or status of IT projects, a lack of clarity on personnel responsibilities, poor project approval processes, and poor resource scheduling processes. Finally, organizational-related challenges my include, for example, a silo organizational structure; a staff not equipped with appropriate skills; IT development knowledge not properly captured, re-used, and managed; inconsistent career management; and over-reliance on contractors or third parties.

To address these challenges discussed above, improvements must be sought in all aspects of the IT development organization, such as the organization's governance, strategy, development capabilities, operations infrastructure, and supporting processes. Improvements in governance may require an IT leadership team with the appropriate business and technical acumen. Improved governance may also be achieved through a business leadership team equipped and motivated to lead the use of IT. Further, a governance structure for IT that clearly defines roles and responsibilities and establishes the forums to provide overall direction for the IT organization may be required to improve governance. Finally, the governance may be improved by implementing management and execution processes that are formal, consistently applied, and results and value oriented.

Improvements in the strategy, architecture and planning may be achieved by implementing IT strategies and plans that are tightly aligned with business priorities and provide an aggressive but realistic roadmap to the future. Improvements in IT development may be realized by providing a development capability that is predictable and cost-effective for both small, focused efforts and large, complex, multiyear initiatives. IT Operations may be improved by incorporating an operations infrastructure that is modular, scalable, stable, and secure. Supporting processes, such as human resources, finance, procurement, etc., may also be a means for improvement of IT development by providing fiscal and financial controls that enable effective management and deployment of IT assets, resources, and activities that drive the right value at an acceptable cost.

IT Transformation (ITT) is the large-scale fundamental change to an IT organization's processes, technology, and culture which reduces cost, improves return-on-investment (ROI) and creates the strong capabilities required for modern IT programs and services. The objectives of ITT are to meet the challenge areas discussed above: financial factors, customer needs, internal operations, and overall corporate organization. Financial objectives may include reducing the overall IT expenditures; reducing non-discretionary IT expenditures; and increasing the return on investment (ROI) from IT. Customer-based objectives may include improving the IT organization's relationship with the overall business and increasing the quality of services. Objectives for internal operations may include providing comprehensive management information; ensuring smooth running of the organization; and using resources efficiently. Objectives for the overall corporate organization may include improving delivery capabilities for all services, in particular, for strategic programs and creating a change-ready culture.

Methodologies to incorporate ITT may easily develop into a complex state of affairs that become too elaborate or overwhelming for practical implementation. Similarly, methodologies that require extensive materials leading up to their implementation may fail to achieve the momentum necessary for successful implementation. Conversely, methodologies that may appear concise may include only superficial changes that lack the desired long-term transformational effect for the IT development organization.

Methodologies to implement ITT may typically be implemented by two basic approaches, internally driven and externally driven. The ‘externally driven’ approach is typically quite directive. Typically, there is a dedicated transformation-implementation team, usually composed of both client and outside consultant personnel, with the consultants being dominant. The team sits “outside” the organization, and is accountable for identifying the issues inside the organization; determining the corrective actions required in terms of structures, processes, and culture; designing the new structures and processes; implementing the new structures, processes and behaviors into the organization. In the “externally driven” model, the consultant plays the role of shaping and leading the change journey; leading the various project teams addressing IT governance, IT development processes, management controls, and culture change; and communicating with and training the internal staff in the new processes, tools, and behaviors.

The ‘externally driven’ approach to implementing ITT can provide advantages. For example, the external approach can make rapid progress in identifying issues and designing new processes or may be more effective in providing clear direction to the organization. Conversely, disadvantages of the externally driven approach may include the disincentive for the organization to buy in into the externally proposed changes. Also, the changes may not be sustained once the transformation team disbands. Furthermore, it can be difficult and time consuming to implement the changes presented by the external organization.

Turning now to the “internally driven” approach to implementing ITT, this approach seeks to lead the organizational transformation from within the IT organization. An executive team, for example, made of people primarily within the IT development organization take full accountability for the transformation of their organization. This internal team will shape and create the change program and merge the change program with day-to-day work. Such a team may actively lead the workstreams and drive the change down through the organization. Because the transformation team is integral with the existing IT development organization, changes in the personal behaviors of the transformation team serve as models to the rest of the organization. Members of the internal transformation team can communicate passionately and continuously on the change to their teams and develop their capabilities so that they can create similar commitment and energy in their staff.

Others within the IT development organization—those not part of the formal internal transformation team—also participate actively in the change, with the change becoming a key part of their goals and objectives. Staff members may be involved in intensive working parties to address specific organization, process and culture issues. Even in the internally driven model, outside consultants are still used to create the framework for the change journey, to facilitate and support the executives in shaping and leading the change journey, to coach the executives in motivating and leading their staff, to facilitate and support working parties in addressing key issues, and to provide specialist input on various of topics, such as IT governance, IT development processes, management controls, and culture change.

The ‘internally driven’ approach to implementing ITT can provide advantages. For example, the internal approach creates ownership within the IT organization for the new structures, processes and behaviors and builds the capabilities of the client organization, from executive level down. The concept of client ownership is more likely to lead to sustainable change. However, the internally driven approach requires strong leadership and commitment from the internal executive team, which must be capable of changing their own behaviors and leading their organization through difficult change. Also, the transformation program may take time to generate momentum, as it requires, first, development of ownership and passion in the executive team, and, then for the executives to cascade this to their staff.

To be effective in multiple IT development organizations, the employed IT transformation methodology must incorporate repeatable diagnostic techniques. This diagnostic must be able to assess the capabilities of an IT development organization and identify and prioritize the issues that an IT development transformation program should focus on. The diagnostic must, therefore, provide a framework that assesses all relevant areas of the IT development organization. The assessment should have the right balance between “breadth” and “depth.” Because it is important to cover all aspects of the organization, the depth of the assessment must be kept at a manageable level. The assessment should be able to incorporate both qualitative and quantitative measures. Ideally, such a diagnostic method could be used during an opportunity assessment and or at the start of an IT transformation program.

While business entities may have addressed some of the challenges and choices to transform their IT development organizations, an overall packaged approach of accomplishing IT development transformation is needed. Such an approach must be structured to be easily replicated across different IT development organizations while able to be tailored to the needs of each organization. Effective IT development transformation methodologies should provide financial improvements, meet customer needs, enhance internal operations, and align with the overall corporate organization.

### BRIEF SUMMARY OF THE PRESENT INVENTION

To address the challenges described above, the present invention provides approaches to assist the practitioner in transforming information technology (IT) development organizations. The methods are repeatable for implementation among multiple IT development organizations, yet can be tailored to the individual needs of each organization. The methods are designed to address the challenges faced by IT development organizations due to financial factors, customer needs, internal operations, and overall corporate organization. The present invention includes several components including an IT transformation overview; an IT organization diagnostic; an IT transformation approaches, tools and techniques phase; an IT development plan; a business case for transformation; and a sample deliverable presentation.

The IT transformation overview summarizes the challenges faced by a typical IT organization, providing context for the value and benefits that an IT transformation (ITT) program can deliver. It also provides an overview and definition of IT transformation outlining the major components of ITT and the relationship between IT development and IT Transformation.

The IT development organization diagnostic provides a framework for assessing the core development capability of an organization and prioritizing the key issues for a development organization. It can be used during the opportunity assessment phase or at the outset of an IT development transformation program. A presentation outlines the framework and provides sample questions that could be used to gauge the capability of the IT development organization.

The IT transformation approaches, tools and techniques phase assess the two major approaches to conducting development transformation (i.e., internally led; externally driven). It lists the advantages and disadvantages of each approach and identifies the circumstances under which each is appropriate. It also outlines sample tools and techniques that can be used during a transformation program.

The presentation of an IT development transformation methodology describes the in detail the packaged methodology for conducting an IT development transformation. It describes in detail the components of the methodology including descriptions, the key tasks involved and the resource requirements based on information gathered from initial diagnostics.

The business case for transformation focuses on the primary objectives of IT transformation, which are to reduce cost and to improve delivery capability. The quantitative business case for IT transformation programs is built primarily on cost reduction. This presentation details the cost reduction levers that can be used and the range of benefits typically obtained.

Finally, in a preferred embodiment, sample deliverables typically produced during an IT development transformation program are presented. Detailed deliverables can be reviewed to foster ideas for change within the existing organization.

In preferred implementation, the present invention provides transformation workstreams that implement actions as needed to expedite the IT development transformation. The IT development transformation workstreams includes a transformation leadership workstream, a vision & operating model workstream, a management controls workstream, a customer management workstream, a development processes and tools workstream, an organizational development workstream, and a program management workstream. Each of these workstreams includes a number of substreams and components. Many of these Workstreams are performed concurrently, thereby offering an expedited, more efficient transformation.

### BRIEF DESCRIPTION OF THE DRAWINGS

A more complete understanding of the present invention and advantages thereof may be acquired by referring to the following description taken in conjunction with the accompanying drawings in which like reference numbers indicate like features, and wherein:

FIG. 1 illustrates a IT transformation method in accordance with embodiments of the present invention;

FIG. 2 depicts an IT diagnostic process as used in the IT transformation method of FIG. 1 in accordance with embodiments of the present invention;

FIG. 3 depicts an exemplary depicts an IT diagnostic produced in the an IT diagnostic process of FIG. 2 in accordance with embodiments of the present invention;

FIGS. 4A-4B and 5-11 depicts the steps in an IT transformation workflow to expedite IT transformation method of FIG. 1 in accordance with embodiments of the present invention;

FIG. 12 depicts the steps in a method for developing a business case as used in the IT transformation method of FIG. 1 in accordance with embodiments of the present invention; and FIG. 13A-B schematically depicts a IT Transformation tool for implementing the steps of IT Transformation method of FIGS. 1 and 4 in accordance with embodiments of the present invention.

### DETAILED DESCRIPTION OF THE PREFERRED EMBODIMENTS

The present invention generally relates to an IT development transformation method 100. The IT development transformation method 100 is about fundamentally changing an organization. Specifically, it changes the culture of the organization; organization structure of roles and responsibilities, processes, and tools. Such a level of change in the development transformation method 100 requires a vast injection of organizational energy, commitment and passion since organizations tend to continue existing practices. There are two fundamentally different approaches which can be taken, Externally Driven or Internally Led, and the these two approaches are described in greater detail below. The present invention provides a variety of tools and techniques that can be used to support the Transformation process using either of these approaches.

The externally driven approach is typically quite directive, and generally includes the use of a dedicated transformation team that sits outside the organization, and is accountable for (1) Identifying the issues in the organization; (2) Determining the corrective actions required in terms of structures, processes, and culture; (3) Designing the new structures and processes; and (4) Implementing the new structures, processes and behaviors into the organization. The external driven approach offers several advantages, including potentially making rapid progress in identifying issues and designing new processes and providing clear direction. However, the external driven approach may be disadvantageous because the transformation team may not get buy-in from the organization for the proposed changes, the changes may not be sustained once the transformation team disbands, and recommended changes may be difficult and time consuming to implement. Ideally, the external approach is used in the diagnostic phase 200 when an objective external assessment is required in order to accurately access the organization, even if the assessment is negative toward the existing management. The external approach may also be advantageous if sustainable change within the existing organization is not required, such as the outsourcing of large components of the organization, or if the management of the organization does not have the capability to lead a Transformation. The external approach is also desirable if the organization wishes to dramatically change the existing management.

In contrast, the internally driven approach implements change through the existing executive team or management, thus having people controlling the current operations oversee the changes in these operations. Accordingly, the existing management takes full accountability for the transformation of their organization as part of their goals and objectives. The management shapes and creates the change program, and typically merges the change program with existing day-to-day work. The management actively leads the workstreams and drives the change down through the organization. These tasks may require the management officers to change their own personal behaviors, to communicate passionately and continuously on the change to their teams, and to develop their capabilities so that they can create similar commitment and energy in their staff. In the internal approach, the staff generally participates actively in the change, with the change becoming a key part of their goals and objectives. Moreover, the staff is involved in intensive working parties to address specific organization, process and culture issues. Accordingly, the role of the present invention in the internal approach is to create the framework for the change journey; to facilitate and support the Executives in shaping and leading the change journey; to coach the Executives in motivating and leading their staff; and to facilitate and support working parties in addressing key issues; to provide specialist input on a wide range of topics, including IT Governance, IT Development processes, Management Controls, Culture Change. The internally driven approach generally creates ownership within the client organization for the new structures, processes and behaviors; builds the capabilities of the client organization, and often leads to sustainable change. However, the internally driven approach is often has disadvantages of requiring strong leadership and commitment from the client executive team, who must be capable of changing their own behaviors and leading their organization through difficult change. The internal approach may be advantageous when sustainable change is required, when the organization's management is capable and receptive to the proposed needed changes.

One key to IT Development Transformation method 100 is to create the ownership and commitment within the client executive team so that they accept and understand the need for change. The management, in turn, must cascade that ownership and commitment throughout the organization. Toward this goal, the IT Development Transformation method 100 strives to allow the organizations executives to build the change plan, rather than enforce a plan produced by a distrusted third party. The executive team should identify the priority issues and determine how best to address these. The issues and their resolution will vary from one organization to the next, but the present invention works with the executive team to determine which workstreams are appropriate and create the change plan. The present invention further works directs the organization to establish a Program Sponsor & Leadership because the program 100 can have a major impact on the roles and responsibilities of the executive team. Thus, IT Development Transformation method 100 fosters strong active leadership from either the Group CIO or sponsoring Business Head. Moreover, the IT Development Transformation method 100 is non-prescriptive in that it outlines the superset of workstreams which can be applied at various stages during a Transformation program as desired by the organization management.

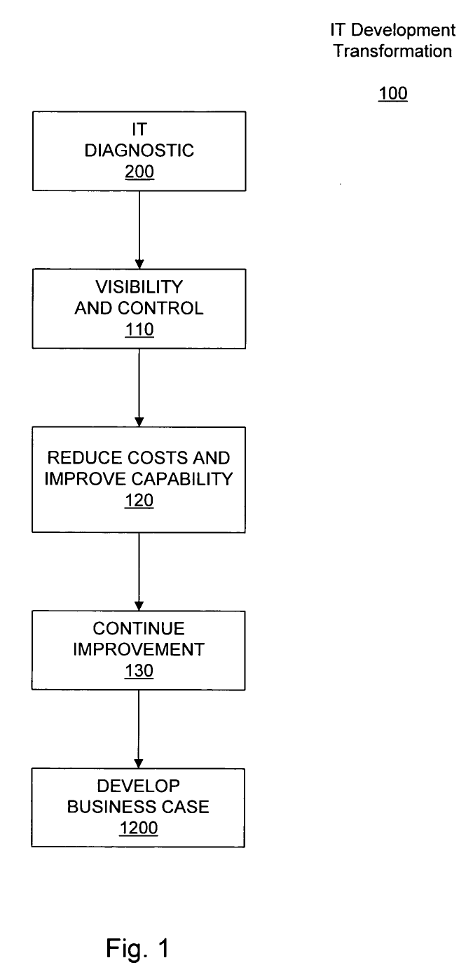

In view of these needs, turning now to FIG. 1, the IT transformation method 100 implemented in embodiments of the present invention optionally begins with an organization diagnostic 200 to assess the present state of the organization. Following the diagnostic step 200, the IT development transformation method 100 continues with visibility and control in step 110, cost reduction and improvement in capability in step 120, and continued improvement in step 130.

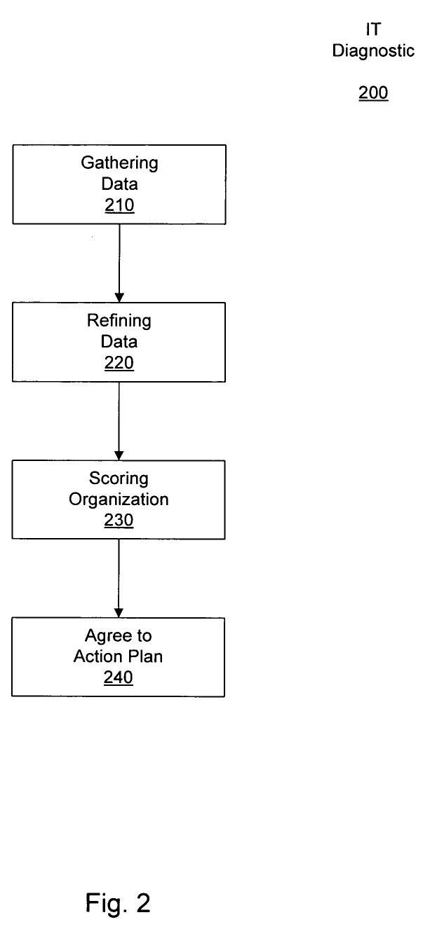

Turning now to FIG. 2, the Development Organization Diagnostic performed in step 200 is a framework for accessing the core development capability of an organization and prioritizing the key issues for a Development organization. It can be used during the Opportunity Assessment phase or at the outset of an IT Transformation program. The purpose of the Development Organization Diagnostic is (1) to assess the capabilities of an IT Development Organization and (3) identify and prioritize issues on which a Development Transformation program should focus. The Organization Diagnostic does this by providing a framework that assesses all relevant areas of the organization. The Organization Diagnostic generally occurs during an Opportunity Assessment and/or at the start of an IT Transformation program, as described in greater detail below. The Organization Diagnostic of step 200 measures the core capability of an IT Organization. Specifically, the Organization Diagnostic helps to identify and prioritize issues on which a Development Transformation program should focus.

In performing a diagnostic, an organization should adhere to several guiding principles. Typically, the assessment should have the right balance between “breath” and “depth”. It is vital to cover all aspects of the organization, so the depth should be kept at a manageable level. Likewise, the emphasis of the diagnostic will vary from the organization to the next, depending on the client's view of their key issues. The assessment should involve both qualitative and quantitative measures. Qualitative measures should be scored based on the assessor's experience and industry practice.

Turning now to FIG. 2, the following discussion outlines the framework and provides exemplary questions that may be used to gauge the capability of the organization. The organization diagnostic of step 200 begins with gathering data in step 210. The gathering of the data in step 210 generally includes requesting quantitative data from appropriate executives, line management and staff, such as gathering qualitative data from interviews, workshops and observation. The data obtained in step 210 is next refined in step 220 by reviewing the received data to understand the method of calculation, integrity etc. The refining of the data in step 220 may include filling in data gaps, such as providing estimates as needed to perform the diagnostic because the required data may not be available in many organizations. The refined data is then used in step 230 to score the organization based on the qualitative and quantitative data received, industry benchmarks, judgment and experience score the metric, associated quadrant and overall organization. The score from step 230 may further outline the Strengths, Weaknesses and Opportunities per quadrant and for the organization as a whole. The organization diagnostic of step 200 continues with Agreeing to an Action Plan in step 240 to confirm the score with the organization executives to ensure that the client executive accept and understand the scores and the rationale behind the scores, and to further agree to the required next steps to start moving the organization to a desired state. These steps in the organization diagnostic of step 200 are now discussed in greater detail.

Returning to FIG. 2, the organization diagnostic of step 200 begins with the gathering of data in step 210 as needed to score the organizations performance in financial criteria, customer service criteria, internal operation criteria, and organization criteria. In gathering data related to the organization's financial performance, the objective is to assess how much IT is costing, whether it is spending in the right areas and to determine the organization's return of investment from its IT. Quantitative Data related to financial performance to be considered during step 210 may include defining IT spending in absolute monetary terms and as a percentage of the organization's total revenue and total operating cost; defining a ratio of IT cost-to-value ratio, the ratio of strategic spending to non-strategic spending; determining the organization's ROI from its IT; the level of staff utilization; the level of staff chargeability; the bad debt position in monetary terms; the net budget position; and the average daily rate, internal daily rate and external daily rate. Similarly, qualitative data related to financial performance often includes indicia about the ease of obtaining management information and the transparency of the budgeting process.

In gathering data related to customer services performance, the objective of data gathering in step 210 is to collect qualitative and quantitative data on customer to assess how well the organization delivers projects and day-to-day service. Types of quantitative data in collected step 210 include an accounting of the number of projects underway; the number of projects on schedule and on budget; a rating of customer satisfaction; determining the project management processes and tools are in place; and determining the software development processes and tools are in place. Similarly, types of qualitative data to be collected in step 210 include data indicating whether customer satisfaction is measured formally and informally; data reflecting whether the customer receive regular status updates; and the key problems with the organization from a customer perspective.

Turning back to FIG. 2, in gathering data related to internal organization, the objective of data gathering in step 210 is to assess the governance and management of the IT function and to assess the efficiency and effectiveness of the internal operations of the organization. Types of quantitative data related to the organization's operation model include assessing the effectiveness of the following; defining board-level Leadership of IT within the organization; defining strategic management of IT; defining operational management of IT; defining management reporting of IT; defining resource management of IT staff; defining vendor management; defining financial management of the IT function; defining knowledge management; defining time recording; and defining facilities and infrastructure.

Continuing with FIG. 2, in gathering data related to organization management, the objective of data gathering in step 210 is to access the capability of the organization from a structure, skills and people point of view. Types of quantitative data related to the organization management include quantitative data about staff satisfaction; staff turnover; the average duration of the staff's service; the customer satisfaction rating with the IT people. Types of qualitative data related to the organization management include indications about the organization structure, about the effectiveness of the organization structure, and about the accountabilities of IT employees for important tasks. Other types of qualitative data related to the organization management include indications about the presence and effectiveness of formal career and performance management processes; information about how is training conducted; information about how performance management and career management are conducted; information about whether knowledge maximized and re-used in the organization; information about the current skill levels and the core values of the organization; whether there is a long-term vision and plan for the organization, and information about how are resources managed and scheduled.

Returning to FIG. 2, the various types of data collected in step 210 are then refined in step 220. The objectives of the data refinement in step 220 are to review the data calculation and integrity and to provide estimates where data is not available. With the quantitative data, the refining step 220 may include, where data is not available, obtaining best-guess estimates from a range of client members or conduct some sampling/surveys. The estimates are then reviewed, and where it is not possible or appropriate to provide an estimates, the data category is left as unknown. With qualitative data, the refining step 220 may include attempting to understand the underlying agendas and internal politics; interviewing more people if required; and pushing back on opinions. After the refining step 220, the organization should understands the data and be ready to score its IT.

Continuing with FIG. 2, the refined data from step 220 is used to score the organization's IT program in step 230 to provide the organization with an indication of its core capability and to highlight the strengths, weaknesses and opportunities for the organization. Toward this goal, the organization is scored in a variety of metrics and a concise explanation of the reasoning behind the scores are preferable provided. The scores from separate metrics may then be used to the score the organization's performance in several categories, such as the above-described groupings of financial performance, customer service, organizational capabilities, and internal operating model and to document the strengths, weaknesses, and opportunities of the organization for each categories. The organization may further be scored on its overall performance and to determine the overall strengths, weaknesses and opportunities for the organization.

Returning to FIG. 2, the scoring from step 230 is used to form in step 240 an action plan that to agree on the high priority areas; to shape the overall Transformation; and to create an action plan. Key tasks in forming the action plan in step 240 include discussing the findings of the diagnostic with the executive team; ensuring that the executives understand the rationale behind each score; management agrees to the high priority areas; creating an overall plan for the transformation of the organization, including creating an action plan for the first portion of the program. Overall, after the action plan formation in step 240, the organization should understand the need for transformation, create an overall journey map and decide the immediate next steps in the transformation.

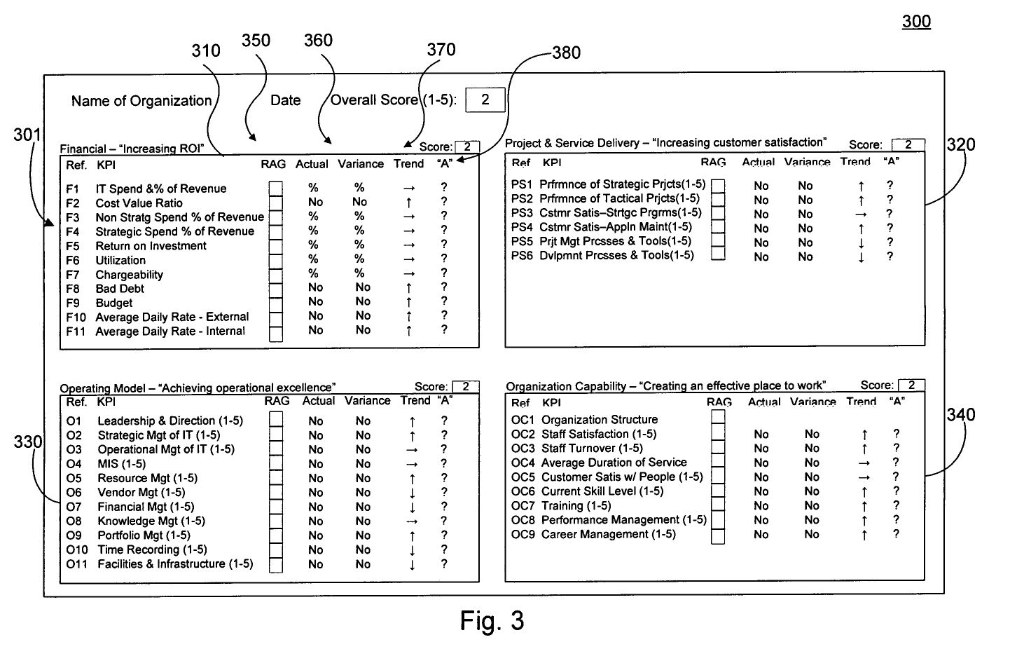

Turning now to FIG. 3, the Organization Diagnostic of step 200 generally entails the organization walking through a series of questions to ascertain Key Performance Indicators (KPIs) 301 that provide a framework to access the core capability of an IT Organization the Based on the IT challenges faced today. An exemplary Organization Diagnostic worksheet 300 is displayed in FIG. 3. The organization diagnostic worksheet 300 grades the organization in a series of criteria. Continuing with FIG. 3, the organization diagnostic worksheet 300, is generally divided into separate categories to address different aspects of IT performance, such as financial criteria 310, customer service criteria 320, internal operation criteria 330, and organization criteria 340. It should be appreciated that the development and grading of the organization's IT is a generally known process. The particular questions and criteria included in the organization diagnostic worksheet 300 may vary as needed, for example, to assess organizations of different sizes or types.

In a preferred implementation, the present invention employs a framework, as depicted in the organization diagnostic worksheet 300, that uses both qualitative and quantitative measures to assess and score the organization to compares, where possible, against industry best practices (i.e., the accepted performance standards). For example, a color-coded rating 350, such as Red, Amber or Green (RAG), may be assigned to each KPI, based on the actual measure, its trend and its comparison against benchmark/best practice. In this type of a color-coded rating 350, Red means there are significant issues, Amber means there are some minor issues, and Green means the performance is good. An overall score is then assigned to the criteria grouping (310-340) based on the sum of the KPIs individual scores in each of the groupings. Typically, Scoring the organization, a quadrant, and a KPI requires experience and judgment on behalf of the user and buy in and acceptance by the client executive team.

Continuing with FIG. 3, optionally, the organization diagnostic worksheet 300 may further include other information, such as industry comparison 360 that displays possible variances against industry benchmarks or organizational objectives. Trend data 370 may, where possible, display the changes in the organization over time to show whether or not the organization is improving. The organization diagnostic worksheet 300 may further contain an accountability designation 380 that indicates who in the organization is accountable for the performance of each of the KPIs. Asking this question can be revealing because poorly performing organizations tend to have poor measurement and unclear accountabilities.

Returning now to FIG. 1, the next steps in the IT development transformation 100 of the present invention are Visibility & Control phase 110, Reducing Cost & Improving Capability phase 120, and Continual Improvement phase 130.

Visibility & Control phase 110 has a first objective of the executive team collectively confirming their commitment to change and to communicate this confirmation to the organization. A second objective of the visibility and control phase 110 is to get visibility of the organization in terms of determining (1) the Number and status of projects; (2) the number of staff and the projects on which they are working; (3) Utilization and chargeability; (4) Financial position; and (5) Customer satisfaction. A third objective of the visibility and control phase 110 is to gain control over projects, people, and finances. This may involve implementing a new organization structure, new roles and responsibilities and new management controls.

Accordingly, the visibility and control phase 110 includes getting the executive team to objectively assess their organization and confirm the necessity for change, particularly if it affects their roles and responsibilities, and this requires strong CIO Leadership to challenge the executive team. Furthermore, the visibility and control phase 110 may entail changing the organization structure if required, so the executive team must identify and agree that a new organization structure is required. This need for organization structural change must then be communicated to the organization and the process and timetable clearly set out as part of the visibility and control phase 110, and again, strong CIO Leadership is required. The visibility and control phase 110 further includes getting data on financial spend and project status. If this data is not readily available, then the visibility and control phase 110 includes establishing a number of working parties to collate a good base of data within a reasonable time period. Continuing with the visibility and control phase 110, the executive team should communicate the need for change to their staff, so the it development transformation should include a well-crafted communications plan, which incorporates formal events where the executive team lead the sessions and present to their staff, informal sessions where staff can question of the executives, and publicly available information that prominently describes the program 100. The visibility and control phase 110 further includes getting the executive team to act as a team, work together and drive the change program, for example, setting a calendar for the executives to insure that they have time to work together.

Returning now to FIG. 1, the IT development transformation method 100 continues with reducing costs and improving capability step 120. Cost reduction is a core objective of Transformation process 100, and typically, savings are achieved through reducing the cost of application maintenance, through improved classification, improved work practices. Further saving can be achieved reducing costs and improving capability step 120 by reducing the amount of tactical spending through better governance; reducing the amount of management overhead through better Management information systems (MIS) and improved operational procedures; and reducing labor costs through better sourcing strategies.

At the same time, reducing costs and improving capability step 120 generally includes improving capability positions of the IT function to add greater value to the business units it serves, increasing customer satisfaction and improving the financial return on IT investments. Improved capability is typically achieved through leadership development programs, focused capability development programs, sourcing strategies, changes in culture and behaviors, and improved software development tools and processes.

During the reducing costs and improving capability step 120, the organization baselines the cost of the organization, but data may not be available, the organization may need to make reasonable estimates to avoid the expenditure of excessive resources in baselining. The reducing costs and improving capability step 120 may further include implementing the new processes, including changes in behavior, particularly governance and approval processes. In this capacity, the reducing costs and improving capability step 120 may include using Working Parties with cross-organizational membership to define and implement the new processes. These parties will create ownership of the new processes. Also, the reducing costs and improving capability step 120 may include getting the Working Parties to run communication sessions to explain the process to their peers. Thus, each Working Party optimally has an executive sponsor to ensure that it has the authority to force in change if required. Likewise, staff bonus payments may be linked to the success of the organization.

The reducing costs and improving capability step 120 further includes improving Development productivity. For repetitive tasks, such as application maintenance, development productivity can be measured and improved in the medium term through new tools and processes. However for one-off activities, such as strategic programs, it is much more difficult to measure productivity, and improvements take a long time. Measurement techniques such as function point analysis, lines of code per day, etc. should be used carefully.

Continuing with FIG. 1, the next step in the IT development transformation method 100 is continual improvement phase 130. During the continual improvement phase 130, the IT development transformation method 100 winds down and processes are implemented to help insure that changes carried out during the transformation are preserved and continued. Thus, the continual improvement phase 130 includes motivating the executives and staff to continually assess and improve the organization, across all dimensions, to implement capability development programs to equip the organization to continually change, and to incorporate an agenda of continual change as part of the organization and built into all staffs' objectives. For example, a working team may agree to meet at 3 months interval to monitor existing changes to assess the need for additional changes.

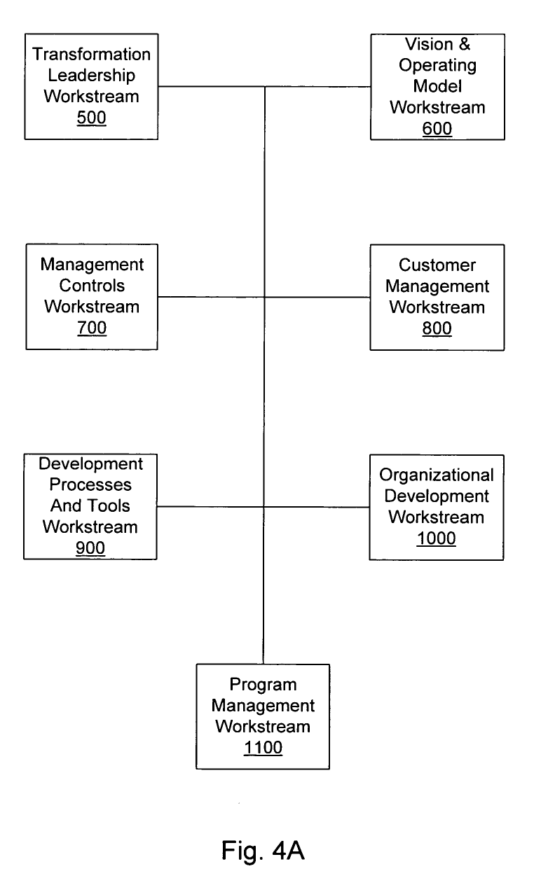

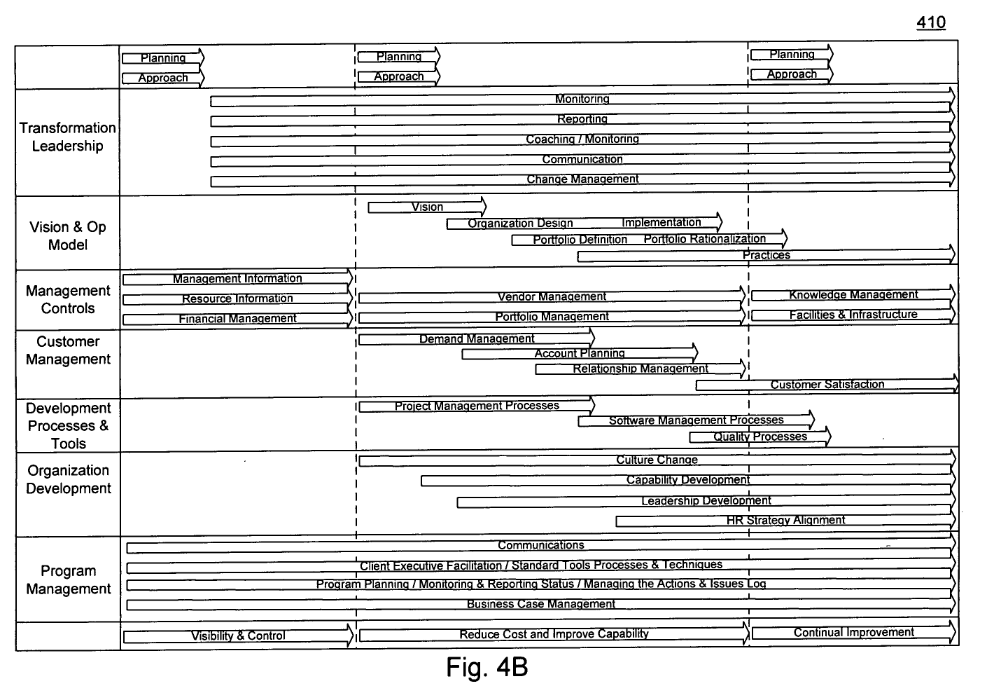

As may be appreciated in the above discussion of the steps in the IT development transformation method 100, it may be possible to streamline or other improve the operation of the IT development transformation method 100 through a series of more concrete operations. Accordingly, embodiments the present invention provides that the IT development transformation method 100 may be carried out through a series of concurrent IT development transformation workstreams 400, as described below, that implement actions as needed to expedite the IT development transformation method 100, as depicted in FIG. 4A. The IT development transformation workstreams 400 includes transformation leadership workstream 500, vision & operating model workstream 600, management controls workstream 700, customer management workstream 800, development processes and tools workstream 900, organizational development workstream 1000, and program management workstream 1100. Each of these workstreams includes a number of substreams and components, as described in greater detail below.

Turning now to FIG. 4B, a graph 410 displays the relationship of the IT transformation workstreams 400 with the IT transformation method 100. Specifically, it can be seen that many of the workflows are performed concurrently, thereby offering an expedited, more efficient transformation.

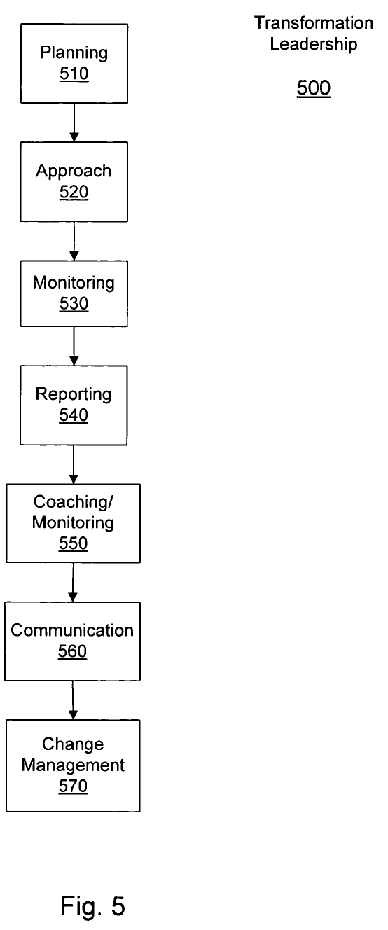

Turning now to FIG. 5, the operation of the transformation leadership workstream 500 relates to shaping, leading and continually reappraising the program. Usually, these programs are run in waves, with a major reassessment/replanning periodically. The transformation leadership workstream 500 is now discussed in greater detail. The transformation leadership workstream 500 generally begins with transformation leadership planning step 510 when The executive team plans the program, setting the overall long-term goals (2 years), and then decompose the program into waves/phases of 3 to 6 months each. For each wave, the team defines the theme, the goals to be achieved, what working parties are required, who is involved, etc. Key Tasks in the transformation leadership planning step 510 includes determine the long-term goals of the program, defining the waves/phases, with their associated themes, and defining the next wave in detail—goals, workstreams, and resourcing.

Concurrent with the transformation leadership planning step 510 is a concurrently performed transformation leadership approach step 520. The transformation leadership approach step 520 addresses the need that often a Transformation program requires changes to the composition and roles of the Executive team. Specifically, the transformation requires changes to the way in which the Executive team and interact with one another and the rest of the organization. The objective of the transformation leadership approach step 520 is for the executive team to define how they should work as a team, when they meet, how they interact with the rest of the organization, etc. Key tasks in the transformation leadership approach step 520 include defining goals for Executive team, agreeing to roles and responsibilities; defining ground rules; and agreeing to a modus operandi.

The transformation leadership workstream 500 then continues with the performing of a monitoring step 530, a reporting step 540, a coaching and monitoring step 550, a communications step 560, and a change management step 570, as indicated in FIG. 5.

The monitoring step 530 is directed to problematic varying over time of the focus, pace and impact of the change program. The Executive must continually monitor the organization and take whatever action is appropriate to continue to drive the organization forward and make it successful. Thus, a key task in the monitoring step 530 includes creating a scorecard with which to assess progress of the organization. The monitoring step 530 further includes regular or periodic assessing of the progress of the working parties, other change projects and the organization as a whole. The monitoring step 530 further includes making required amendments to plans.

The monitoring step 540 relates to committing to a transformation program. Specifically, committing to a transformation program is effectively a public commitment by the IT organization to the rest of the business. Thus, the program has a wide range of stakeholders who must be updated. Regular updates to these groups, with consistent messages, are very important. These stakeholders typically include the Group Executive who will usually have to sign-off on the business case, the business units who, as customers of IT, will be keenly interested in progress, and IT staff. Key tasks in the monitoring step 540 include determining program stakeholders, creating a plan for updating stakeholders, and conducting regular updates.

Turning back to FIG. 5, the transformation leadership workstream 500 continues with the coaching and mentoring step 550 to encourage behavioral change and to deal with the personal impact of the program. Toward these goals, the executives should implement a coaching/mentoring plan step 550 where each executive is assigned a number of senior managers who typically do not report to him directly. The role of the executive is to have informal sessions where they listen to the concerns of the manager, offer advice, and reinforce messages. This technique should be cascaded throughout the organization. Key tasks in step 550 include determining the role of coaching/mentoring program, designing the program, assigning and training coaches, and implementing the program.

The communication step 560 addresses the need continual, passionate communication as one of the key ways of introducing the change program, creating buy-in and moving people along the change curve. A key principle of transformation is that change should be cascaded through the organization, i.e., each level is accountable for motivation and leading the staff that report to them. To make this happen, communications should be cascaded, and a wide range of techniques are available including set piece events, weekly status meetings, one-to-one meetings, and visual displays. Key tasks in the communication step 560 include developing a communications plan, implementing the communications plan, and assessing the effectiveness of communications using known methods.

The transformation leadership workstream further include change management step 570. A transformation program has enormous impact on the staff of the IT organization, and their roles and reporting lines may change, the processes and tools they use will change and the mood and culture of the organization in which they work may change. Managing the impact of this change on their staff is the primary role of the executive team. If the change is managed and communicated correctly, then the majority of staff will buy into it. However some will not—they may lack either the will or the skill to change. Management will have to deal with these people within the confines of the Human Resources policies of the organization. Thus, key tasks in the change management step 570 may include assessing the change in the readiness state of the staff of the organization, identifying the change agents and change blockers, Developing a plan to use agents, developing a plan to minimize impact of blockers, and implementing change plans

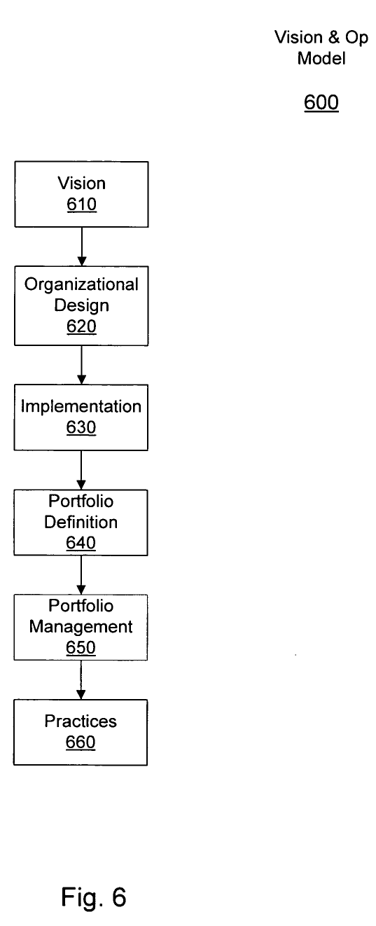

Turning now to FIG. 6, the substeps of the vision and operating model worksteam 600 is described in greater detail. IT organizations that are under-performing tend to have ineffective organizational structures. They do not have a clearly defined strategy or vision. Roles and responsibilities are not clear, and organizational structures tend to exist with poor utilization of staff. Thus, the objectives of the vision and operating model worksteam 600 are for the executive team to determine the desired end-state for the organization, to define the operating model required to support this, and to implement this new operating model. The objectives of the vision and operating model worksteam 600 also includes reviewing all existing work in the organization with the objective of shutting down low value projects, reducing cost. The vision and operating model worksteam 600 includes vision step 610, organization design step 620, implementation step 630, portfolio step 640, portfolio rationalization 650, and practices step 660.

The vision step 610 addresses the need of documenting the current state of the IT and listing the priority issues. This may have be done during the Organizational assessment (OA) 200. The desired end-state for the organization is now defined. It should include scale (how many staff), portfolio of work (compliance, tactical, strategic), relationship to the business units, sourcing strategy, skills and capabilities required, etc. Articulating this vision is central to creating a momentum for change within the organization. A roadmap outlining interim stages is then created. Accordingly, the vision step 610 includes a current state assessment to determine priority issues; defining the desired end state in terms of scale, portfolio of work, skills, technology, and sourcing; defining a road map with interim targets, and creating change program.

Changing the organizational structure in the organization design step 620 is a key step in the transformation of an organization. The organization design step 620 provides the executives with an opportunity to reduce cost, empower staff, create scheduling flexibility, remove “dead wood” and promote energetic and capable staff. However the organization design step 620 can also be challenging for the executives in that it is likely to change their roles. Thus, strong leadership from the Group CIO/Business Head is required. There are a number of different organizational structures which can be implemented. Which one is chosen depends on the end-state vision for the organization, the priorities of the organization and the availability of qualified executives and staff. However there are a number of key underlying principles to which the executive team must adhere. Thus, the organization design step 620 often includes defining guiding principles for the new organization. The organization design step 620 further includes defining the various options on organization structure, evaluating the options, and choosing a best fit. The organization design step 620 may further include the defining of roles, grading criteria, and defining standard practices for the new organization.

The vision and operational model 600 further continues with organization implementation step 630. Implementing a new organizational structure takes considerable time and effort. In terms of selecting people for roles, the executive team have to decide on what approach they wish to adopt: whether just to appoint people or embark on an intensive series of private meetings with all available candidates. The latter approach is recommended as it creates buy-in and gives the executive an opportunity to assess the change readiness/capabilities of their staff. Thus, key tasks of the organization implementation step 630 may include determining an implementation approach, creating an implementation plan, communicating a new structure and plan, conducting the personal meetings; assessing candidates and making, creating transition plan, conducting the handover process, and cutting over to new organization.

Based on the Vision defined in step 610, the Executive decides what the portfolio of work is for their organization in step 640. The leaders need to clearly define each type of work (strategic, compliance, tactical, maintenance, support) and the governance rules for commissioning work in step 640. Then using the new Organization Structure, the high level process flows, and associated accountabilities/responsibilities, for each type of work are defined. The portfolio definition step 640 may include defining the categorization rules in the new organization and governance rules for commissioning work. The portfolio definition step 640 may further include define high level process flows and grading criteria.

Turning now to a portfolio realization step 650, a working party should be established to review all work currently being executed in the organization. Each piece of work should be reviewed under a number of headings: objectives, type of work, business case, sponsor, budget and schedule status, resources. An assessment is then made as to whether that piece of work should continue as is, be stopped or be reconfigured. This process is excellent for eliminating low value work from the organization, thus reducing cost. Consequently, key tasks in the portfolio realization step 650 include creating Terms of Reference for Working Party. Then, the executives define criteria by which to assess each piece of work. An inventory of all existing work may be created as well. The reviews are then conducted, and the executives use this information to make decisions on each piece of work, such as whether to continue, stop, or reconfigure the work.

Continuing with FIG. 6, the visions and operations model workflow continues with the practices step 660. If the client decides on a project-based organization structure, practices should be set up. Practices, (or resource pools), allow organizations to place greater emphasis on projects, as resources are no longer ‘owned’ by functions but are aligned to a Practice through their skill set, e.g. Business Analysis. Practices are a best-practice industry model, which allows the organization to focusing on developing organizational capability, improving performance management and career development processes and implementing best practice across the organization. Thus, key tasks for the practices step 660 include designing a practices framework, where a working party should also be set up to design the Practices Framework and to develop the process, procedures and grading criteria. Next, the practices are mobilized once the Practices Model is designed, so that employees are assigned to Practices based on their skill-sets. Once the Practices Program Plan is in place, the Practice Leads hold their meetings to explain the purpose of Practices and the importance of employee involvement in order to implement and institutionalize the practices. The Practice Leads meet formally to discuss progress and to ensure resource scheduling, capability development and performance management procedures are being followed

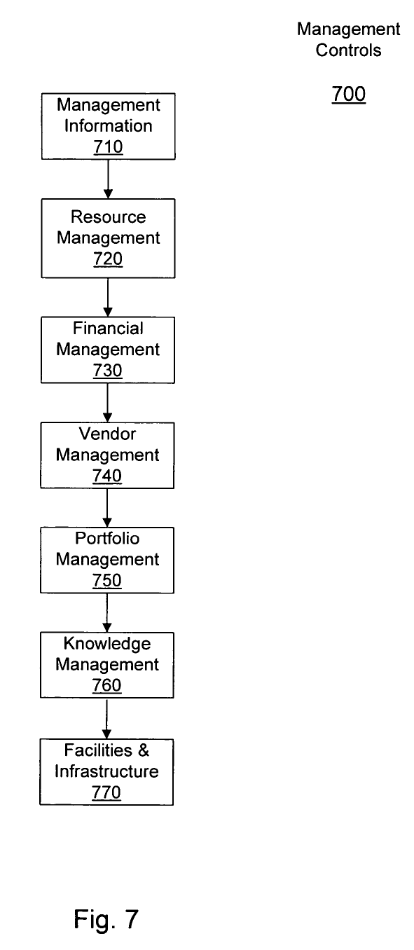

Turning now to FIGS. 4 and 7, another workstream in the IT development transformation workstream 400 in the management controls worksteam 700. Strong management control within the IT organization is critical to ensuring optimal use of resources, effective cost management and good visibility of the KPIs for the organization. The key to success is to run the IT organization as a quasi-commercial business. For most organizations, there is significant scope for cost reduction and improvement in management MIS. Accordingly, key objectives of this workstream are to design, build, implement and institutionalize the processes and tools required for operational excellence and to identify and implement cost reduction initiatives. The Management Controls workstream 700 is composed of 7 substeps, as represented below and illustrated in FIG. 7.

Relentlessly driving the organization forward by reducing costs and improving capability requires everyone to have access to and to use good MIS. Management information step 710 includes creating a balanced scorecard covering financials, customer, internal operations and people, and this type of scorecard is both a management and a communications tool. Bonus payments may also be linked to the achievement of certain targets in the scorecard. Thus, key steps in the Management information step include defining MIS requirements; designing, building and implementing the scorecard tool; and designing, building and implementing scorecard processes.

In regard to the resource management step 720, in a project-based organization, good resource management processes are critical. They allow the organization to plan, ensuring that the right people with the right skills are available for projects. They help reduce costs by tracking utilization and chargeability, allowing management to continually increase the level of utilization achieved. Thus, the resource management step 720 includes designing, building, and implementing: (1) a resource database; (2) Scheduling processes and tools; (3) Time recording processes and tools; and (4) Utilization and chargeability processes and tools.

Continuing with the management control workflow 700 of FIG. 7, the financial management step 730 addresses the need of the IT organization to be run as a business in its own right. From a financial perspective, the IT organization can be a cost centre or a profit centre. Either way, a strong commercial focus will ensure that costs are managed effectively and that a business plan is created and executed. The financial management step 730 address these needs by defining the financial structure for the IT organization (cost centre, profit centre, source of funds, etc.). Then a annual Business Plan for the IT may created for the IT organization. To better accomplish these tasks, the financial management step 730 may include designing, building, and implementing budgeting tools and processes, invoicing tools and processes, and financial/management accounting tools and processes.

Similarly, vendor management step 740 is needed because good vendor management processes facilitate cost reduction in two areas. First, hardware and software license fees reductions may be achieved through rationalization of suppliers and consolidation of license fees. Secondly, contractor and partner costs reductions may be achieved through better visibility, contractor reduction, utilization of offshore sourcing and contract management/negotiation. These processes also help the organization to identify strategic partners, build relationships and leverage the strengths and contacts of these partners. The vendor management step 740 then includes defining an approach to vendor management; defining vendor management processes; reviewing hardware and software suppliers and contracts; developing sourcing strategy; reviewing contractors: contractor conversion/substitution; and reviewing of strategic partners.

Turning now to the portfolio management step 750, in the Vision and Operating Model workstream, categorization rules, governance rules, high level processes and grading criteria are defined. In this workstream 750, the processes and tools for ongoing management of the portfolio of work for the organization are designed, built and implemented. These processes are required to keep tight control on the work requests entering the organization, ensuring that the organization focuses on strategic work. They also give good visibility of the status of all work in the organization. The key tasks of the portfolio management in step 750 include the designing, building, and implement of a portfolio database, which is database of all work in the organization. Tools and processes for Portfolio administration and reporting, may also be designed, built, and implemented, along with tools and processes for systems planning.

Turing now to the knowledge management step 760, knowledge management is the capture, storage and utilization of knowledge capital, such as project documents (plans, designs, test scripts), business knowledge and technical knowledge. Leveraging knowledge reduces the cost of new projects, reduces project timescales and reduces dependency on key resources. Key tasks in step 760 include trying to define an approach to knowledge management; to define assets and capital to be managed; and to design, build and implement required processes and tools.

Similarly, costs can be saved through effective facilities management in step 770. This facilities management in step 770 may involve consolidation into one central location, provision of remote access/home working, etc. Such activities also improve the productivity of staff. Accordingly, related key tasks include an as-is analysis of current physical and technical infrastructure (i.e., prior to any additional transformation); determining optimal physical configuration; a determining of optimal technical infrastructure (LAN, WAN, Internet); and creating an appropriate action plans and implementation strategy.

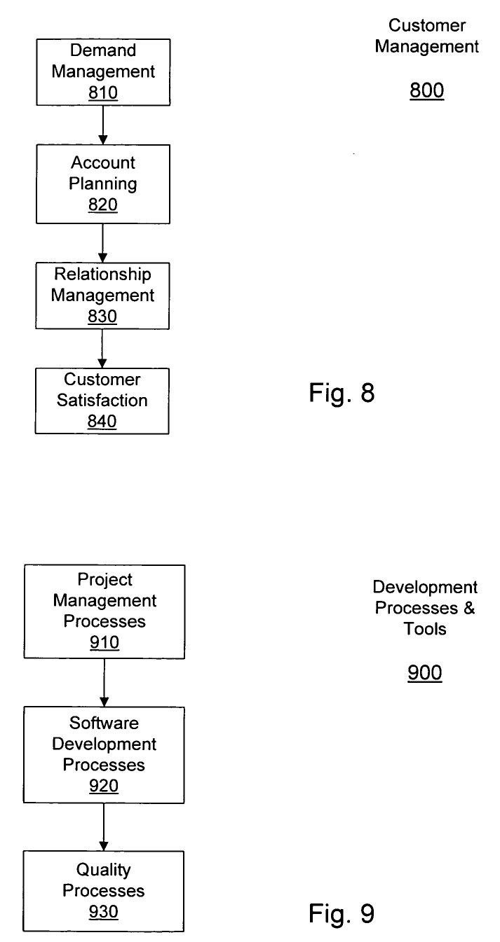

Turning now to FIGS. 4 and 8, the next of the IT transformation workstreams 400 is the customer management workstream 800. Customer centricity is often a key to the success of a transformation. The customer management workstream 800 is focused on aligning the organization more closely with the customer in order to understand, predict and fulfill their needs, as well as managing and measuring customer satisfaction levels. A demand management step 810 and an account planning step 820 are focused on gathering and managing client requirements. Then, a relationship management step 830 focuses on managing the ongoing expectations of client regarding service delivery, and a customer satisfaction step 840 focuses on measuring the current performance of the organization from the customer perspective.

The demand management step 810 encompasses both short term (up to a year) and medium to long term (one to five years) planning and management of the demand for IT services. Short term demand management involves the collation of demand up to 1 year and the management of expectations around that demand. This involves balancing the strategic versus tactical work requested, prioritizing work requests as well as liaisoning with the resource scheduling process to ensure demand is met in the appropriate time frame. In contrast, medium to long term demand management during demand management step 810 involves the collation of long term business plans, and translating these into broad IT needs (in terms of size, and skill requirements), so that as those plans become reality and so that the development organization is well positioned to meet that demand. Thus, the demand management step 810 generally comprises the design, building and implementing of the tools and process for capturing demand from clients. Next, demand management is integrated with the overall planning process for IT.

The Account Planning process 820 helps IT organizations to better manage their approach to customers, grow revenues, increase customer retention, build and expand the customer relationship. The creating of an account plan in step 820 begins with the gathering of relevant information about the customer/account in order to develop an understanding of the account's current situation and to classify the account (e.g., high-value or low value) according to an established set of criteria. The goals and objectives for the account are then defined and a plan created to achieve these goals. To further these goals, the organization may design, build and implement a standard template and process for account planning, and then use these templates to create the account plans.

The relationship management step 830 is focused on identifying who are the key customers, how they wish to interface with the IT function and then aligning the IT organization to meet these requirements. The relationship management step 830 includes performing client mapping in order to understand who the clients are, their roles, etc. Then, each client executive mapped to an IT executive/senior manager in order to create a personal responsibility for each client. The organization then sets out a plan for building relationships with the clients. The relationship management step 830 may optimally includes define a standard operating practice, or modus operandi, regarding how client relationships, e.g., such as how demand is captured, when and where status meetings with clients are held, a format for status reports to the clients, how issues are escalated and resolved, etc.

Continuing with FIG. 8, customer satisfaction measurements may be acquired during customer satisfaction step 840 as a key measure of the success of any Transformation program and any organization in general. Customer satisfaction step 840 should formally measure on a periodic basis for input into the management scorecard. Informal feedback from the customer is preferably consistently sought and relayed back to the appropriate managers within the organization. In this regard, channels of escalation regarding customer satisfaction should be well defined and widely understood. Because perception is reality when it comes to satisfaction, it often vital that customer expectations and relationships are managed appropriately on an ongoing basis. Aspects of the customer satisfaction step 840 typically include designing, building and implementing the processes and tools for measuring and reporting customer satisfaction. Moreover, the organization should agree to a processes for escalating customer satisfaction issues.

This workstream is focused on improving the core delivery capability of the organization by introducing and instutionalizing best practice behavior in software development. This involves designing, building, implementing and institutionalizing the processes and tools required for software development excellence as well as institutionalizing the desired behavior within the software development community.

As depicted in FIGS. 4 and 9, the IT transformation workstreams 400 continues with the development processes and tools workstream 900. The development processes and tools workstream 900 focuses on three areas, a project management step 910, a software development step 920, and quality step 930. The development processes and tools workstream 900 should increase the level of control during project delivery, the ease with which resources can move from one project to another, transparency on performance levels by enabling like with like comparisons, and the ability to share and reuse knowledge in the organization. The deliverables produced as part of the development processes and tools workstream 900 should leverage best practice as defined by the Business Integration Methodology and be designed in conjunction with the appropriate communities in the organization ensuring a solution that fits.

Turning now to FIG. 9, the objective of the project management step 910 is to introduce “best practice” project management processes, tools and behavior to the organization. To ensure the deliverables are taken up by the project management community there should be an equal emphasis placed on energizing and changing the behavior of project managers, defining and documenting best practice project management processes and releasing a suite of tools that support and reinforce the defined processes. Accordingly, the project management step 910 generally includes energizing the project management community through involvement, consultation and communication. The project management step 910 may further include defining and documenting best practice processes in project management by referring to standard building information modeling (BIM) methodology and tailoring the proposed process to the needs of the organization. The project management step 910 may further include the design and building of a suite of project management tools, including estimating tools, an earned value and tracking tool, a risk and issue management tool, and a document repository that including standard templates by phase available to download, as described in greater detail below.

Turning back to FIG. 9, the objective of the software development processes 920 is to introduce “best practice” standard software development processes, tools and behavior to the organization. This enables the benefits of improved quality and reliability; reduction in the amount of rework; reduction in the cost of correcting problems; requirements traceability allowing informed scope decisions; improved risk management; and improved performance against budget and schedule. A Business Integration Methodology may be used as the reference material for the software development processes 920. Specifically, the software development processes 920 generally includes the task of identifying and prioritizing areas in the software development process that can be improved. Moreover, the organization should define “best practice” software development processes by referring to a known BIM methodology. Continuing with the software development processes 920, the organization may further define standard templates, tools and techniques that reinforce best practice processes.

Turning again to FIG. 9, the level of effort that is put into defining, documenting and implementing quality processes will depend greatly on the objectives of Transformation. The focus on quality from an ITT perspective should be on how continuous improvement can be promoted within the organization with minimal additional effort or overhead and without resorting to a full total quality management (TQM) type program. A key tool for quality and continual improvement is a project review and quality assurance process in the quality processes step 930. The quality processes step 930 should preferably be implemented on peer-review basis. In this way, the quality processes step 930T helps to ensure that projects adhere to the required processes and tools. Furthermore, the quality processes step 930 provides an objective assessment of the state of a project, and helps to develop communication and knowledge sharing among the project management community. In view of these goals, the quality processes step 930 generally includes define the key processes and tools which should be used on all projects. The quality processes step 930 further includes the defining and building of the quality assurance processes and tools, as well as the training of project managers in how to conduct project quality assurance processes. Finally, the organization, as part of the quality processes step 930, should implement the created project quality assurance processes.

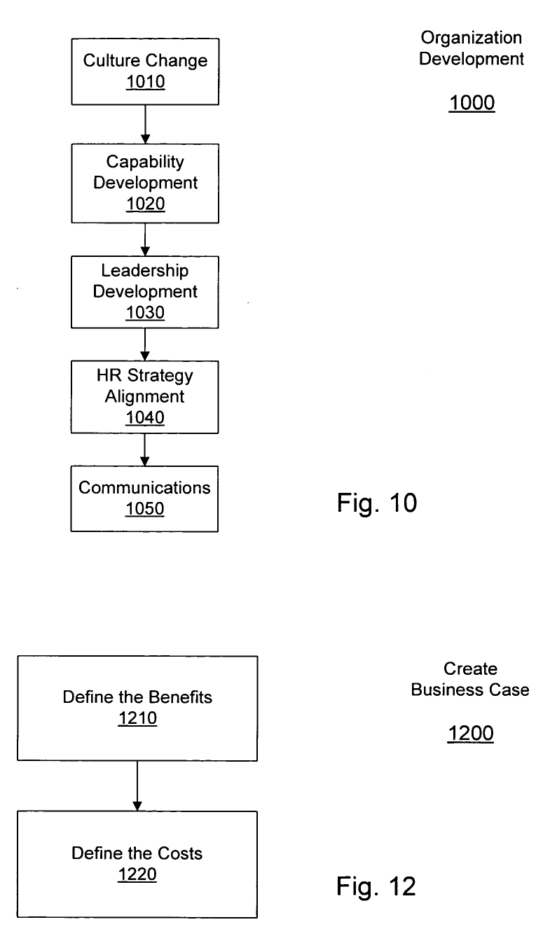

Turning now to FIGS. 4 and 10, the organizational development workstream 1000 underpins the working of the new organization and facilitates the creation of a highly motivated and truly empowered workforce. Step 1000 specifically outlines clear models of the desired behaviors required to support the strategic intent, enables core business processes and contributes to the desired business outcomes. As depicted in FIG. 10, the Organizational Development Workstream 1000 is composed of five substeps, including a culture change step 1010, a capability development step 1020, a leadership development step 1030, a HR strategy alignment step 1040, and a communications step 1050.

The culture change step 1010 helps to create an adaptive, change-ready culture the help to ensure that the organization can respond rapidly and effectively to both internal and external changes. Culture is the way things are done around in the organization, and it drives employee's work habits by influencing the way they think, feel, react to and execute their jobs, all of which has a direct relationship to business performance. Companies with adaptive and visionary cultures significantly outperform others. Accordingly, the culture change step 1010 a current state assessment that determines the current culture and provides a baseline against which any subsequent interventions can be measured. The culture change step 1010 further includes determining desired future culture, since once the current state is identified, the desired future state must be determined since the future state will outline the desired vision, values and behaviors required for the organization to be effective. Next, the culture change step 1010 includes comparing the current and future cultures, so that any gaps will be highlighted and recommendations made to bridge these gap, because it is important that an appropriate measurement mechanism is put in place to ensure the organization is moving towards the appropriate culture. The culture change step 1010 preferably further includes a rollout and launch of the new culture in a creative and effective manner to create momentum around the new desired culture; and once the launch has taken place, the desired behaviors, values, vision should be re-iterated continuously in all communications and ways of working. The cultures should then be institutionalize in the culture change step 1010 by institutionalizing and publicizing the desired behaviors and values and aligning them to the strategy of the organization. In this way, the organization can move forward in an integrated manner. It should be appreciated, however, that the actual institutionalization of a new culture can take years.

The objective of the Capability Development step 1020 is to enable management to develop the capabilities of their staff. The capability development step 1020 addresses both organisational needs (e.g., forward resource planning, assignment of resources, targeted recruitment, selection and career advancement) and individual needs (e.g., skills development, personal development planning). During the capability development step 1020, the organization should design a capability development approach, including developing guiding principles for capability development since the vision and values may underpin all the skills and the development of the proposed capability model). The capability development approach further include developing the deployment workplan and the building of team workstream. The organization continues the capability development step 1020 by developing a proposed capability model. The proposed capability model identifies the skills critical to achieving the business strategy, and demonstrates the ideal skill sets at each level. The proposed capability model will enable management to shape the development of the capabilities of their staff and to enable effective resource scheduling in line with the organisational strategy. Continuing with the capability development step 1020, the organization next performs a current state assessment by developing a survey or audit to identify the current level of technical, people management and commercial skills. In the capability development step 1020, the organization analyzes the skills audit results against the proposed capability model to determine any gaps, strengths and development opportunities. The proposed capability model is the target end-state. However the organisation may be in catch-up mode initially and may concentrate on certain hot-spots. The analysis tool must be capable of providing sorted reports and comprehensive analysis, by practice, role, skill etc. Once the gap analysis is complete, both short and long-term recommendations for closing the gap are outlined, which will provide input into the development of workforce strategies and processes; i.e., personal development plans recommendations, resource scheduling, targeted recruiting. The results should also be communicated to staff. To conclude the capability development step 1020, the organization designs, develops, and implement a training model that addresses the identified skill deficiencies, and the training model sets the direction for how identified development requirements will be addressed.

Continuing with FIG. 10, the leadership development step 1030 addresses the need of accelerating and guaranteeing sustainability of behavioral and attitudinal change throughout the organization, by having the senior management team lead by example to demonstrate the behaviors and capabilities valued by the business). The leadership development step 1030 is designed to support the management team as they take up their leading roles, by providing them with an understanding of the skills necessary to manage more rigorously and play the leadership role more effectively. The leadership development step 1030 begins with the designing and building of a the leadership development step program that is designed to build the capabilities of the senior managers, both individually and collectively as a team. The organization next rolls-out the leadership development program using known techniques such as through a personal development plan (PDP) design and development, psychometric testing, core values 3600 measurement, or an introduction to leadership course. The leadership development step 1030 continues with the implementation and institutionalization of the leadership development. Specifically, the senior management team are responsible for completing the actions outlined in their PDPs. Leadership Development is generally a continuous process, with regular assessment and feedback necessary for identifying strengths and areas for development, succession planning, targeted recruitment, etc.

The HR strategy alignment step 1040 helps to align the HR strategy with the overall vision and strategy of the organization. The HR strategy may need to be revised, based on the new organization structure and the results of the Culture assessment and the capability requirements of the organization. The HR strategy alignment step 1040 begins with a current state assessment, which is a detailed analysis of the current HR department, roles and responsibilities must be undertaken. In addition the current performance management, career development and rewards and recognition process and procedures need to be evaluated in light of the new culture. The HR strategy alignment step 1040 continues with organization prepare an HR charter and plan that sets out the future roles and responsibilities within HR, specifying the changes as a result of the new organization structure and the introduction of career coaches, practice leads and the capability development manager. In addition, changes may be required to HR processes to aid the implementation of the new culture. Where needed, the organization continues the HR strategy alignment step 1040 by reconfiguring HR to support new organization by implementing the changes required to support the new organization.

The communications step 1050 is the process by which the organization achieves understanding and involvement, resulting in increased cooperation and acceptance of change. Throughout the entire Transformation process, it is imperative that there is regular, effective timely two-way tailored communications, and that going forward the culture of open communications is maintained. Thus, communications step 1050 may include a communications audit, in which an evaluation of the current communication processes is conducted to determine what mechanisms are working or failing as input to the creation of the communications plan. In response to this audit, the organization develops a communications plan that provides an overall framework for managing and coordinating the wide variety of communication that will directly or indirectly take place to support the development transformation. The communications plan addresses audiences, messages, communication channels, and phase of commitment and creates a mapping between all four. Such a framework helps ensure that the organization provides relevant, accurate, consistent, tailored information to the organization (both internally and externally), at all times. The organization next runs the communications program, such as holding watershed events, communication effectiveness surveys, employee satisfaction surveys, newsletters, poster campaigns, etc. The organization then institutionalizes the communications plan, thereby internalizing effective communication processes and techniques.

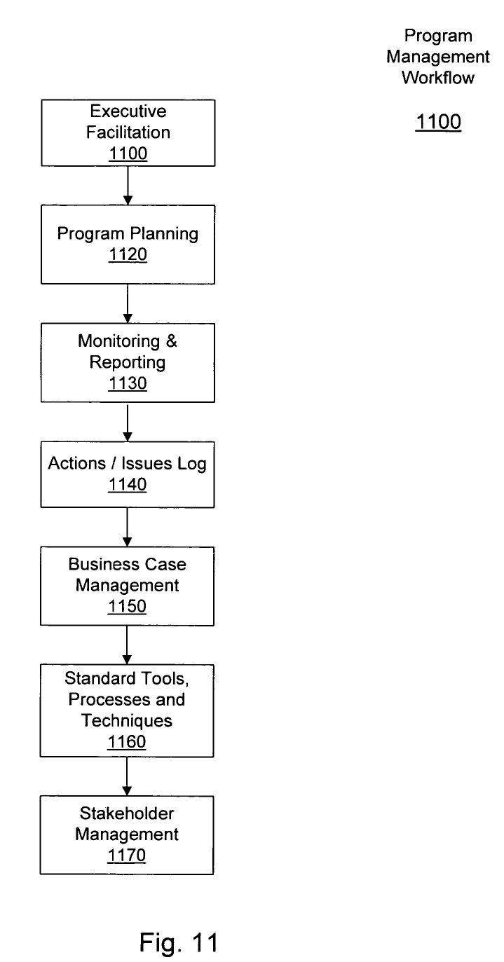

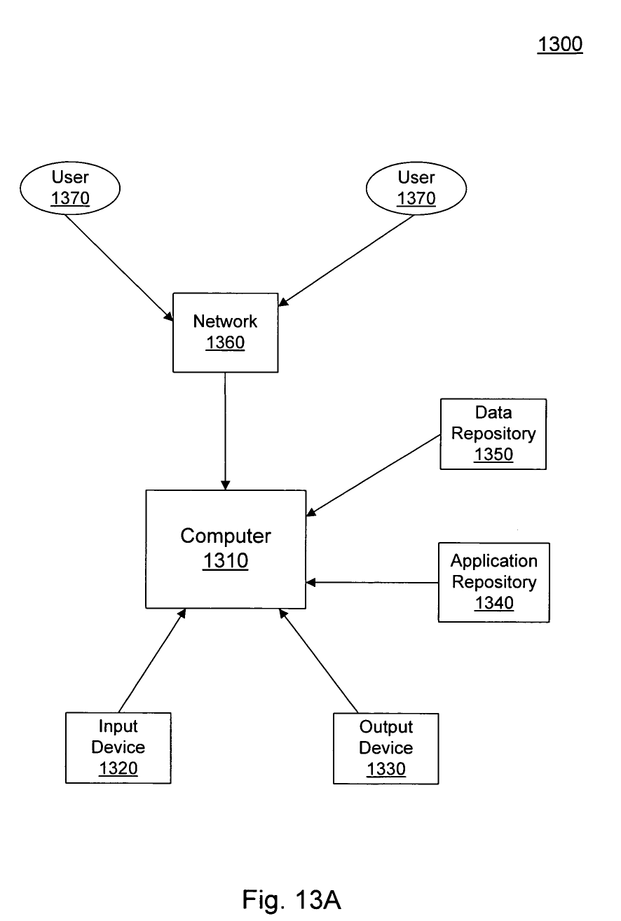

Turning now to FIG. 11, the IT transformation workflows continue with program management workflow 1100. The role of programme management workflow 1100 for development transformation is different to that for traditional technology implementation programmes. The main difference is that the programme manager does not have accountability for implementing the programme. Accountability rests with the line executives. They must lead the change initiatives. The primary role of the program manage workflow 1100 is to facilitate the executive team in their transformation leadership role. The program manage workflow 1100 generally includes an executive facilitation step 1110, a program planning step 1120, a monitoring and reporting status step 1130, a managing the actions/issues log step 1140, a business case management step 1150, a standard tools, processes and techniques step 1160, and a stakeholder management step 1170.

In the executive facilitation step 1110, the transformation team facilitate the executive team in periodic strategy sessions and various offsite sessions. The goal is to assist the executives reach the right answers, provide specialist input on various topics and to continually motivate the team. Key tasks in the executive facilitation step 1110 include planning and facilitating the executive strategy sessions and offsite sessions. The transformation team should further provide specialist input on IT Transformation topics.

Continuing with FIG. 11, during the program planning step 1120, a programme director on the transformation committee works with the executives to create the overall high-level programme plans. These plans tend to be revisited periodically, such as every 3 months. The programme director then decomposes these high-level plans into detailed plans. These plans are the given to the various teams and working parties responsible for implementation. Thus, the program planning step 1120 generally includes defining the long-term and short-term goals of the programme, as well as, defining the work streams for the near future and the detailed plans.

Continuing with FIG. 11, the monitoring and reporting status step 1130 has the programme director continually monitoring the status of the various activities underway. This status is reported to the executives, who then decide on what corrective action to take. The status may also be communicated to the wider staff community. Accordingly, the monitoring and reporting status step 1130 includes the task of monitoring the status of the various working parties and teams, and then reporting status to the organization executives.

Returning to FIG. 11, the managing the actions/issues log step 1140 has the programme director managing the issues and actions logs and using this process to ensure that the executive and senior management team do actually execute their actions. This process needs to managed rigorously, particularly at the start of the programme, to ensure the right behaviours are adopted. Thus, key tasks in the managing the actions/issues log step 1140 include recording the programme issues and associated actions, and regularly reporting on status of issues and actions.

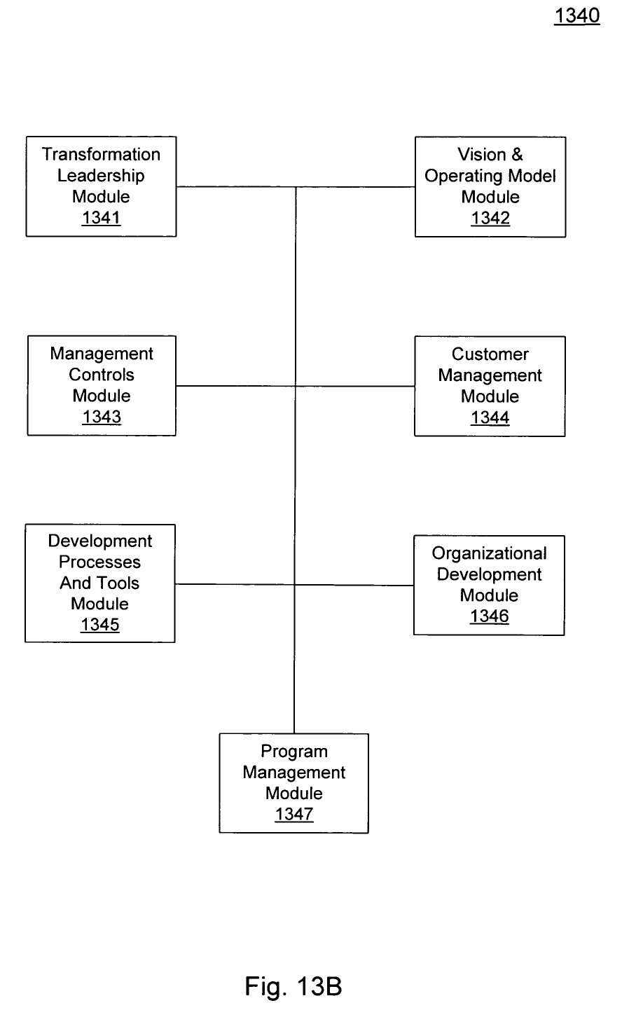

The business case management step 1150 outlines how the business case is defined and managed. It is imperative that the executives understand and own the business case. The programme director typically creates a “strawman” business case and reviews this with the client executive. Once the case has been approved, tracking tools and processes must be designed and implemented. It is important to avoid over-elaboration in the business case, as this will make tracking progress against it very difficult. Approval from internal audit for both the business case and the tacking process is vital. Thus, key steps in the business case management step 1150 include creating the business case that is reviewed and approved by client executive and internal audit. Moreover, the business case management step 1150 includes creating the tools and processes to track progress against the business case, as well as reporting status to client executive and sponsor. The development of a business case is described in greater detail in FIG. 12 and its associated text.

The standard tools, processes and techniques step 1160 comprises introducing new ways of working, standard project management tools and techniques that facilitate smoother running the Transformation programme. Specifically, the standard tools, processes and techniques step 1160 includes introducing tools, process and techniques which increase the efficiency and effectiveness of the executive team and the working parties.

Referring again to FIG. 11, the stakeholder management step 1170 focuses on ensuring that all stakeholders are informed of the progress being made by the programme, that stakeholders are in a position to resolve issues when and if they arise and finally that stakeholder expectations are managed appropriately. Thus, the stakeholder management step 1170 typically includes reporting the transformation status to the sponsor and other stakeholders, and then managing the expectations of the stakeholders.

Turning now to FIG. 12, the development of a business case in step 1200, perhaps as part of the business case management step 1150, generally includes defining the benefits of the transformation in step 1210 and defining the costs of the benefits in step 1220.

The defining of the benefits in step 1210 includes evaluating quantitative benefits such as reductions in the cost of IT, increases in the return on investment (ROI) on IT spending, and increases in the revenue of the IT function. The defining of the benefits in step 1210 further includes evaluating qualitative benefits, including predicting increases in customer satisfaction, improvements in delivery capability and predictability, improvements in internal operations (transparency), increases in staff capability and satisfaction, and the creation of a change-ready, accountable organization.

The steps in the process of defining costs and benefits to IT transformation may be carried according to known techniques and methods. For example, the total cost of IT can be decreased by reducing non-strategic spending, reducing the cost of strategic spending, and reducing labor costs, and these benefits can be measured according to known techniques. Strategic spend is spending associated with strategic projects which create real value for the organization and its shareholders. Such projects have a business case with a strong return on investment. Typically, there are eight areas of non-strategic spend in an IT organization:
Unassigned time
Management overhead
Application Maintenance
Tactical spend
Support and operational costs
Training costs
Hardware and software license costs
Facilities costs

There are a number of techniques which can be used to reduce the cost of theses eight areas of non-strategic spend. For example, All costs in the organization should be measured against budget. Identifying and measuring the cost of unassigned time, training, management overhead etc can reveal interesting trends and behaviors, and allows management to track these costs, benchmark them against other organizations and ultimately reduce these costs. Moreover, within the IT organization, every individual should have clear accountabilities. Likewise, the organization should separate strategic activities from non-strategic to ensure that the accountable executives have clear objectives. Thus, The Head of Strategic Development is accountable for delivering value to the organization, while the Head of Service Delivery is accountable for delivering day to day service at the lowest possible cost. The organization may further benefit by setting aggressive budgets for each overhead area during the annual planning and budgeting process, and each budget should be assigned an accountable owner. The use of automated testing, with standardized test data and test scripts, can also significantly reduce the cost of application maintenance and tactical development. The organization can also gain through the active management of license costs that can grow substantially overtime. Active management of these costs, coupled with supplier management and negotiation strategies can bring significant reductions. Likewise, active management of facilities costs can be beneficial since, in large, diverse organizations, office costs and associated infrastructure can form a substantial part of the cost base. Consolidating buildings and infrastructure can lead to substantial savings.

Further measurable benefits to the organization may be obtained by implementing effective processes and tools for resourcing scheduling (MIS, time recording etc.) that significantly reduce the amount of management overhead and support time consumed in running the IT function. Similarly, the automation of support activities can reduce the number of required employees, and number of needed employees can be further reduced by the proper classification of work allows the best allocation of employee skills, i.e., demand management. Similarly, Workflow tools that enable management to group together similar requests, to allocate them to the right resources, and to track their progress can dramatically improve productivity in application maintenance.

Referring now to FIG. 13A, an IT transformation system 1300 is now provided. Specifically, the IT transformation system 1300 provides a computer 1310 that includes an input device 1320 and an output device 1330. The computer accesses an associated application repository 1340 and a data repository 1350. Embodiments of the IT transformation system 1300 may be connected to users 1370 and distant data repository (not illustrated) via a distributed network 1360, such as the Internet.

As depicted in FIG. 13B, the shareholder value system 800 may be a software-driven application including modules located in the application repository 1340 that automatically perform each of the steps of the IT transformation workstreams 400. Specifically, the application repository 1340 may have modules 1341-1347 corresponding, respectively, to transformation leadership workstream 500, vision & operating model workstream 600, management controls workstream 700, customer management workstream 800, development processes and tools workstream 900, organizational development workstream 1000, and program management workstream 1100.

The data repository 1350 may contain various information and documents as needed to assist the organization through the IT transformation process 100. Specifically, the data repository 1350 may contain instructions to the organization on the steps of the IT transformation. The data repository 1350 may further include a schedule for coordinating the operation of the modules 1341-1347. The scheduler may also note the performance of activities, and therefore prompt the organization as to needed actions to improve or complete the transformation. Similarly, the data repository 1350 may include data collected and used through the transformation process, so that this information is ready for further actions and review, such as cost/benefit analysis of the transformation and to prepare the organization for further transformation. The data repository 1350 may further contain exemplary documents that the organization can use as for guidance when performing the steps of the IT transformation workflow 400. For example, the data repository 1350 may contain exemplary planning documents to show the organization the types of details to be included in a transformation plan.

Conclusion

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols as they are developed. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A system for information technology transformation comprising:
a transformation leadership module;
a vision and operating model module;
a management controls module;
a customer management module;
a development processes and tools module;
an organizational development module; and
a program management module,
wherein said modules are performed concurrently to perform a step for visibility and control, a step for reduce costs and improve capability, and a step for continued improvement.

2. The system of claim 1, wherein the transformation leadership module performs the steps of:
planning;
approaching;
monitoring;
reporting;
coaching;
communicating; and
management change.

3. The system of claim 1, wherein the vision and operating model module performs the steps of:
vision;
organizational design;
implementation;
portfolio definition;
portfolio management; and
practices.

4. The system of claim 1, wherein the management controls module performs the steps of:
management information;
resource management;
financial management;
vendor management;
portfolio management;
knowledge management; and
facilities and infrastructure management.

5. The system of claim 1, wherein the customer management module performs the steps of:
demand management;
account planning;
relationship management; and
customer satisfaction management.

6. The system of claim 1, wherein the development processes and tools module performs:
a project management step,
a software development step, and
a quality evaluation step.

7. The system of claim 1, wherein the organizational development module performs:
a culture change step;
a capability development step;
a leadership development step;
a human resources strategy alignment step; and
a communications step.

8. The system of claim 1, wherein the program management module performs the steps of
executive facilitation;
program planning;
monitoring and reporting status;
managing a actions/issues log;
business case management;
standard tools, processes and techniques; and
stakeholder management.

9. The system of claim 1 further comprising a data repository storing data to be used by said transformation leadership module; said vision and operating model module; said management controls module; said customer management module; said development processes and tools module; said organizational development module; and said program management module.

10. The system of claim 9, wherein the data repository comprises a scheduler for synchronizing the operation of said transformation leadership module; said vision and operating model module; said management controls module; said customer management module; said development processes and tools module; said organizational development module; and said program management module.

11. The system of claim 9, wherein the data repository comprises exemplary documents outputs of said transformation leadership module; said vision and operating model module; said management controls module; said customer management module; said development processes and tools module; said organizational development module; and said program management module.

12. An information technology transformation method comprising the steps of:
a transformation leadership workstream;
a vision and operating model workstream;
a management controls workstream;
a customer management workstream;
a development processes and tools workstream;
an organizational development workstream; and
a program management workstream, wherein said
workstreams are performed concurrently to perform a step for visibility and control, a step for reduce costs and improve capability, and a step for continued improvement.

13. The method of claim 12, wherein the transformation leadership workstream comprises:
a step for Planning;
a step for Approaching;
a step for Monitoring;
a step for Reporting;
a step for Coaching;
a step for Communicating; and
a step for management change.

14. The method of claim 12, wherein the vision and operating model workstream comprises
a step for vision;
a step for organizational design;
a step for implementation;
a step for portfolio definition;
a step for portfolio management; and
a step for practices.

15. The method of claim 12, wherein the management controls workstream comprises:
a step for management information;
a step for resource management;
a step for financial management;
a step for vendor management;
a step for portfolio management;
a step for knowledge management; and
a step for facilities and infrastructure management.

16. The method of claim 12, wherein the customer management workstream comprises:
a step for demand management;
a step for account planning;
a step for relationship management; and
a step for customer satisfaction management.

17. The method of claim 12, wherein the development processes and tools workstream comprises:
a project management step,
a software development step, and
a quality evaluation step.

18. The method of claim 12, wherein the organizational development workstream comprises:
a culture change step;
a capability development step;
a leadership development step;
a human resources strategy alignment step; and
a communications step.

19. The method of claim 12, wherein the program management workstream comprises the steps of:
executive facilitation;
program planning;
monitoring and reporting status;
managing a actions/issues log;
business case management;
standard tools, processes and techniques; and
stakeholder management.

20. The method of claim 12 further comprising the step of forming a business case.

21. The method of claim 12 further comprising the step of performing an information technology diagnostic.

22. A computer-readable storage medium containing a set of instructions for information technology transformation of an organization, the set of instructions implementing a process comprising:
a step for transformation leadership;
a step for vision and operating model;
a step for management controls;
a step for customer management;
a step for development processes and tools;
a step for organizational development; and
a step for program management.
